(19) United States
(12) Patent Application Publication
(10) Pub. No.: US 2013/0282420 A1
(43) Pub. Date: Oct. 24, 2013

(54) SYSTEMS AND METHODS FOR REALTIME OCCUPANCY DETECTION OF VEHICLES APPROACHING RETAIL SITE FOR PREDICTIVE ORDERING

(71) Applicants: Peter Paul, Webster, NY (US); Aaron Michael Burry, Ontario, NY (US); Joel Eagle, Anaheim, CA (US)

(72) Inventors: Peter Paul, Webster, NY (US); Aaron Michael Burry, Ontario, NY (US); Joel Eagle, Anaheim, CA (US)

(73) Assignee: XEROX CORPORATION, Norwalk, CT (US)

(21) Appl. No.: 13/451,938

(22) Filed: Apr. 20, 2012

(51) Int. Cl. G06Q 10/04; G06Q 10/06

(52) U.S. Cl. 705/7.16

(57) ABSTRACT

Embodiments relate to systems and methods for realtime occupancy detection of vehicles approaching a retail site for predictive ordering. A restaurant or other retail site can maintain access areas, such as a drive through lane or parking area, which vehicles can approach to order food or other items. A set of sensors can detect the vehicles, and estimate the number of occupants in those vehicles. Detection techniques can include face detection technology, seat detection technology, thermal imaging, or others. The number of occupants can be estimated and sent to a production management engine monitoring the site. That engine can responsively issue production instructions, such as a number and type of food items to prepare, and when. By integrating an operational model of the site, including projected order amounts and types, with the realtime occupant count, more accurate matching of food or other production to customer demand can be achieved.

### FIELD

The present teachings relate to systems and methods for realtime occupancy detection of vehicles approaching a retail site for predictive ordering, and more particularly, to platforms and techniques for estimating the number of occupants in a vehicle entering a fast food restaurant or other retail site, and using that number as an input to a production management engine for the retail site to adjust the food preparation or other production of the retail site to more closely match the instantaneous demand of the actual number of onsite customers.

### BACKGROUND

In quick service restaurants, like any of a number of well-known “fast food” franchise chains, relatively short bursts of heavy customer traffic can cause bottlenecks in the preparation of food orders. These bursts or peaks may come from, for example, a large local event ending and a large number of event attendees entering a restaurant or a restaurant's drive though queue in a short period of time. The burst or peak may also result from a bus or other large vehicle entering the parking lot of the facility, and many occupants of the bus disembarking and placing orders at the restaurant.

Food in these restaurants is considered fresh for only a limited period of time, and thus the food is usually prepared based on estimated immediate demand. In the absence of the ability to generate an accurate estimate of the number of customers entering the inner or outer ordering areas of the restaurant, this can lead to long wait times for food to cook when large numbers of customers place orders at or around the same time.

Moreover, even when restaurant managers or others attempt to manage the production process of the restaurant by estimating or manually counting the number of vehicles entering an ordering lane or parking for occupants to enter the front counter of the establishment, the number of vehicles serves, at best, as a rough indicator of the number of potential customers and therefore, anticipated orders for the restaurant. This can be due to the fact that the actual number of persons in some vehicles, including those with a large capacity, can vary widely depending on how fully that vehicle is loaded. The actual occupancy of the vehicle may however remain unclear to the manager or others attempting to get a “head count” of customers based strictly on the identified number of vehicles approaching the establishment.

It may therefore be desirable to provide methods and systems for occupancy detection of vehicles approaching a retail site for predictive ordering, in which vehicle occupancy techniques can be applied to vehicles approaching a restaurant or other retail site, generating in an estimated or anticipated number of occupants, customers, and/or forthcoming orders having a much higher degree of precision or granularity than manual techniques or mere guesswork by the restaurant operators, allowing the site to adjust its production process to provide faster, more efficient service and fresher food products and/or other items.

### DESCRIPTION OF DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall operational retail site including electronic detection and other equipment, which can be used in systems and methods for realtime occupancy detection of vehicles approaching a retail site for predictive ordering, according to various embodiments;

FIG. 2 illustrates a flowchart of various processing that can be used in implementations of realtime occupancy detection of vehicles approaching a retail site for predictive ordering, including processing orders from vehicles approaching an ordering point through a access road or other pathway, according to various embodiments;

FIG. 3 illustrates a flowchart of various processing that can be used in implementations of realtime occupancy detection of vehicles approaching a retail site for predictive ordering, including processing orders from vehicles that arrive in a parking area of a retail site, according to various embodiments;

FIG. 4 illustrates a flowchart of various processing that can be used in implementations of systems and methods for realtime occupancy detection of vehicles approaching a retail site for predictive ordering, including processing orders from large vehicles such as buses that arrive in a parking area of a retail site, according to various embodiments; and

FIG. 5 illustrates exemplary hardware, software, and other resources that can be used in systems and methods for realtime occupancy detection of vehicles approaching a retail site for predictive ordering, according to various embodiments.

### DESCRIPTION OF EMBODIMENTS

Embodiments of the present teachings relate to systems and methods for realtime occupancy detection of vehicles approaching a retail site for predictive ordering. More particularly, embodiments relate to platforms and techniques for monitoring vehicle traffic approaching a restaurant and/or other retail site, and generating an estimate of the number of occupants of the vehicle. That estimated number of occupants can be transmitted to an operational model of the retail site, such as a model generated or accessed by a production management engine which generates operating instructions such as the type of food items to prepare, the quantity of those items to prepare, when to begin the cooking or other preparation of those items, and other production details. Because in part the retail site can tie up-to-the-minute production instructions or details to a fairly accurate or granular estimate of the number of vehicle occupants, the efficiency of the retail operation can be improved. In the case for instance of a fast-food restaurant, food can be delivered to a customer in a drive-through line or other access area which is fresher, and delivered on time to the customer as they arrive at the dispensing window or other pickup point, enhancing the customers' experience while reducing waste for the retail operator. Other advantages can also be achieved.

Reference will now be made in detail to exemplary embodiments of the present teachings, which are illustrated in the accompanying drawings. Where possible the same reference numbers will be used throughout the drawings to refer to the same or like parts.

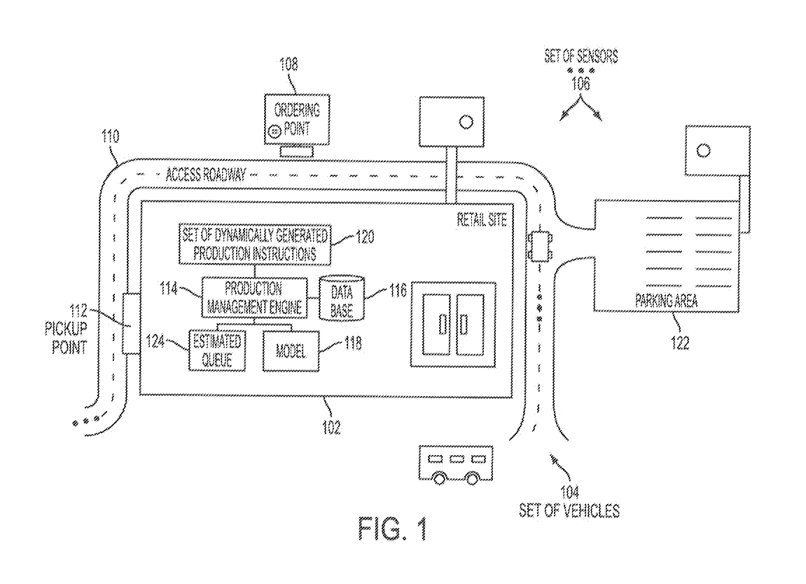

FIG. 1 illustrates an overall network 100 in which systems and methods for realtime occupancy detection of vehicles approaching a retail site for predictive ordering, according to aspects. In aspects as shown, a retail site 102 can have one or more access areas, such as an access roadway 110 and/or a parking area 122, as shown. In aspects, the retail site 102 can be or include a restaurant, such as a so-called “fast food” restaurant, but can also include traditional restaurants as well as other retail establishments. In aspects, the access roadway 110 can include or adjoin an ordering point 108, such as an interactive ordering panel or kiosk including audio connections to a point of sale register within the retail site 102, and/or other location. In aspects, the access roadway 110 can include or adjoin a pickup point 112, such as a drive-through window, a to-go window or door, and/or other access area for the receipt of food orders or other products prepared or delivered by the retail site.

In aspects, the access area or areas including the access roadway 110 and/or parking area 122 can receive a set of vehicles 104, for instance, one or more automobiles, vans, buses, trucks, and/or other vehicles. According to embodiments, the retail site 102 can be equipped or provided with a set of sensors 106 used to carry out occupant detection and other operations related to the retail site 102. According to aspects, the set of sensors 106 can be or include one or more imaging devices, such as video cameras, photo cameras, motion detection devices, sound or acoustic detection devices, and/or other sensors, devices, and/or equipment used to monitor access areas of the retail site 102 including the access roadway 110, parking area 122, and/or other areas. In implementations, the set of sensors 106 can include optical equipment such as strobe lighting such as infra-red illumination strobes that can be triggered upon the approach of a vehicle to emit a strobe or pulse of infra-red light and/or other radiation. According to aspects, the set of sensors 106 can incorporate, and/or can interface to, detection applications, platforms, and/or services to provide detection of the occupants of one or more vehicles in the set of vehicles 104. For instance, the set of sensors 106 can incorporate, and/or can interface to, detection applications, platforms, and/or services based on human face detection technology to identify occupied seats in the vehicle being imaged, to thereby generate an estimated number of occupants in that vehicle. Face detection technology can include any algorithm known in the art to extract into images of the cabin or interior of a vehicle, and locate characteristic facial features such as eyes, noses, mouths, ears, and/or other anatomical features located within certain proportional distances of each other, thereby suggesting or indicating that a person is located within the vehicle. An image of the cabin or interior of the vehicle can indicate the presence of one, two, three, four, and/or other numbers of occupants. In aspects, the set of sensors 106 can operate and/or be configured to operate in realtime and/or near realtime, and/or at other rates of operation.

For further instance, the set of sensors 106 can incorporate, and/or can interface to, detection applications, platforms, and/or services based on seat detection technology to identify unoccupied seats by location, geometrical layout, and/or other features of the vehicle being imaged, to thereby generate and/or reduce the estimated number of occupants in that vehicle, based on the estimated number of empty seats. The set of sensors 106 can likewise use or incorporate other types of detection, such as heat detection technology to identify occupants, especially in cold weather conditions, acoustic detection of one or more voices or other acoustic signatures, and/or other types of detection elements, modes, and/or technology.

In aspects in general, after the set of sensors 106 and/or associated applications, services, logic, and/or equipment has detected an estimated number of occupants in a vehicle in the set of vehicles, the set of sensors 106 and/or those associated resources can transmit the estimated number of occupants of the vehicle being imaged or scanned to a production management engine 114 hosted in the retail site 102, and/or hosted in other local or remote locations. In aspects, the production management engine 114 can be or include one or more servers, platforms, applications, and/or services configured to track, monitor, and manage the production operations and/or other activities of the retail site 102, including to adjust production of the retail site 102 based on data received from the set of sensors 106. In aspects, the production management engine 114 can incorporate and/or interface to one or more local or remote computing resources, including a database 116 which can be or include a local or remote hard drive or drives, and/or other data stores, to store operational data, long-term operational records for the retail site 102 and/or other sites or sources, and/or other information.

According to aspects, the production management engine 114 can incorporate and/or interface to a model 118 that can be used to analyze the activities of the retail site 102, including to predict or project customer demand, production requirements and schedules, and/or other operating characteristics of the retail site 102. For instance, the model 118 can include a predictive model for the amount, type, and/or other features of food products based on an estimated number of current customers entering an access area of the retail site 102. For instance, the model 118 can project that for every five new customers of the retail site, there will be a production requirement of four orders of French Fries, five dispensed soft drinks or other beverages, and three orders of the premium hamburger product. Other projections can be made. In aspects, the model 118 can be based upon, and/or can incorporate or use, historical data recorded for the retail site 102, and/or for affiliated or other retail sites. In embodiments, the model 118 can access that historical data to derive an “average” order by a given customer, which can for instance vary based upon time of day and menu offerings during those times, such as for breakfast, lunch, and/or dinner menus or selections.

According to implementations in further regards, the model 118 can receive or access data from the set of sensors 106, including an estimated number of occupants located in a newly-arrived vehicle in the access roadway 100, the parking area 122, and/or other access area of the retail site 102. Based for instance on the estimated number of occupants for each newly-arrived vehicle, as well as the total estimated number of occupants who remain in line within the access roadway 110, parking area 122, the interior area of the retail site 102, and/or other access areas, the model 118, production management engine 114, and/or other logic, application, and/or service can generate an estimate or prediction for one or more variables or factors used by retail site 102. For instance, the model 118 production management engine 114, and/or other logic, application, and/or service can build an estimated queue 124 which includes an estimate for a total number of customers waiting to place or receive an order, the timing of those orders, the target time for delivery of each order at the pickup point 112, internal delivery of the order at a register or counter inside retail site 102, and/or other parameters related to the delivery of food or other items to customers in line at the retail site 102. In aspects, the model 118, production management engine 114, and/or other logic, application, and/or service can generate and/or estimate other parameters such as estimated freshness of food items when expected to be delivered, the quantity and/or type of food items whose preparation must be started to satisfy the expected orders from the estimated queues 124, a number of attendants at the registers or counters of the retail site 102, and/or other variables, quantities, or parameters. In aspects, the model 118, production management engine 114, and/or other logic, application, and/or service can analyze those and other parameters of the retail site 102, and generate a set of dynamically generated production instructions 120 to tailor production output and other details of the retail site 102 to estimated immediate demand, and/or based on other detected conditions.

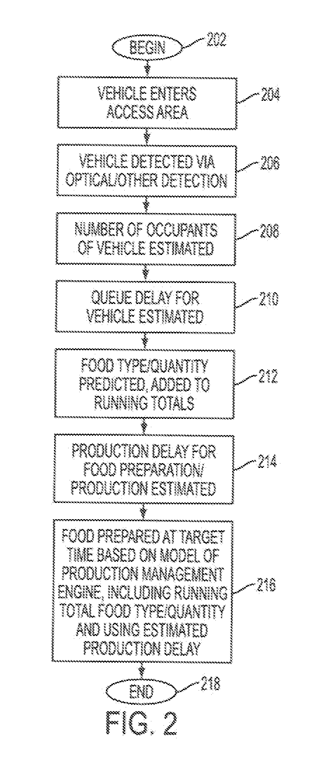

The set of dynamically generated production instructions 120 can be generated for a variety of conditions and/or situations involving different kinds of vehicles, approach paths taken by potential customers, and/or other factors. More specifically, and as for instance illustrated in FIG. 2, in accordance with the present teachings, the model 118, production management engine 114, and/or other logic, application, and/or service can perform certain processing in connection with an approaching vehicle that arrives via the access roadway 110 and/or other approaches. In 202, processing can begin. In 204, a vehicle can enter an access area of the retail site 102, such as the access roadway 110 and/or other approach. In aspects, the vehicle can be or include, for example, an automobile, a van, a sport utility vehicle (SUV), a passenger truck, a commercial truck, a motorcycle, and/or other vehicle. In 206, the number of occupants in the approaching vehicle can be estimated, for example, by sensing optical, infra-red, thermal, acoustic, and/or other signals from the set of sensors 106, and applying face-recognition and/or other pattern-matching or detection techniques to the detected signal or signals associated with the vehicle.

In 210, the model 118, production management engine 114, and/or other logic, application, and/or service can generate or estimate a queue delay for the subject vehicle, for instance, by determining the number of vehicles and/or orders in front of the subject vehicle reflected in the estimated queue 124, and/or other data. In aspects, the queue delay can be, merely for instance, on the order of one minute, three minutes, five minutes, and/or other intervals or amounts of time. In 212, the model 118, production management engine 114, and/or other logic, application, and/or service can predict or estimate a food type and/or quantity that will be generate by the forthcoming order from the subject vehicle, and those types and/or quantities can be added to running totals maintained by the production management engine 114 and/or other logic, application, and/or services. For example, if the approaching vehicle is estimated to contain three occupants, and all occupants are assumed to be customers and/or adding to the order associated with the vehicle, then production management engine 114 can adjust or update the set of dynamically generated production instructions 120 based on those factors. For instance, the production management engine 114 can interface to model 118 to estimate that two orders of French fries, two hamburger, and one rotisserie chicken food items will be likely to be reflected in the order for the vehicle, based on historical averages and/or other factors. Those quantities can then be added to the quantities of all food items or types required to service the estimated queue 124, and reflected in the set of dynamically generated production instructions 120 and/or other actions or outputs. It may be noted that in aspects, estimated or predicted food types, items, and/or quantities can be updated to reflect actual orders received at the ordering point 108 or otherwise, as those orders are received, on a real-time or near real-time basis. Other parameters used in the production operations of the retail site 102 can also be refreshed based on new vehicle estimates, orders received, and/or other information.

In 214, the model 118, production management engine 114, and/or other logic, application, and/or service can generate or estimate a production delay for food preparation of the food items expected or received from the subject or newly-detected vehicle and its estimated number of occupants. In aspects, the production management engine 114 and/or other logic, application or service can determine that the expected or necessary time for preparation of the food items that are expected or received from the subject vehicle is four minutes.

In 216, the model 118, production management engine 114, and/or other logic, application, and/or service can generate a set of dynamically generated production instructions 120 and/or other outputs specifying that the corresponding total quantities of food items be prepared at one or more target times, based on the model 118 maintained or accessed by the production management engine 114. Thus, and merely for example, the production management engine 114 can issue instructions that preparation of one order of rotisserie chicken, having the longest preparation time, be begun immediately in order to be available to the customer immediately after expiration of their queue delay, while preparation of two hamburgers be initiated in two minutes, and preparation of two orders of French fries be started at one minute before the expiration of that queue delay, respectively. Other food types, quantities, and timing points can be used, but in all instances the model 118, production management engine 114, and/or other logic, application, and/or service can attempt to minimize customer delay in receiving their order, while maximizing freshness of the product received and efficiency of the production operation of the retail site 102. In 218, processing can return to a prior processing point, jump to a further processing point, repeat, or end.

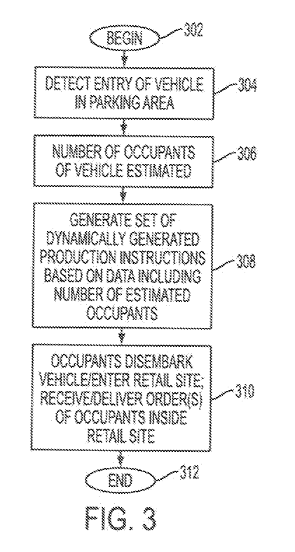

FIG. 3 illustrates a flowchart of overall processing that can be used in embodiments of systems and methods for realtime occupancy detection of vehicles approaching a retail site for predictive ordering, according to further aspects. In scenarios encompassed by the processing of FIG. 3, a vehicle can approach the parking area 122 of the retail site 102, with the occupants disembarking from the vehicle to enter a lobby or other internal ordering point of the retail site 102. In 302, processing can begin. In 304, the entry of a newly arriving vehicle in the parking area 122 can be detected, for instance via the set of sensors 106, embedded magnetic pavement loops, optical beam sensors, and/or other types of detection. In 306, the model 118, production management engine 114, and/or other logic, application, and/or service can estimate a number of occupants in the vehicle, again, based on face detection, seat detection, thermal detection, and/or other sensing technology or techniques.

In 308, the model 118, production management engine 114, and/or other logic, application, and/or service can generate a set of dynamically generated production instructions 120 based on the estimated number of occupants in the vehicle arriving or parking in the parking area 122. Thus, for instance, if one occupant is detected in the subject vehicle, the set of dynamically generated production instructions 120 can include instructions to begin preparation of one hamburger, one order of French fries, and/or other combinations or quantities of food items. In 310, the occupant(s) of the subject vehicle can disembark from the vehicle and enter the retail site 102, where the actual order of the occupant(s) can be received and/or delivered, again with increased efficiency based on the more-accurate estimate of occupants entering the site to place an order. In 312, processing can return to a prior processing point, jump to a further processing point, repeat, or end.

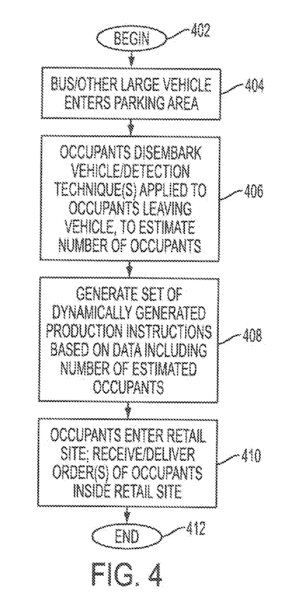

FIG. 4 illustrates a flowchart of overall processing that can be used in embodiments of systems and methods for realtime occupancy detection of vehicles approaching a retail site for predictive ordering, according to further aspects. In scenarios encompassed by the processing of FIG. 4, a particular class or type of vehicle, namely a bus and/or other large-scale vehicle or carrier, can approach the parking area 122 of the retail site 102, with the occupants disembarking from the vehicle to enter a lobby or other internal ordering point of the retail site 102. In 402, processing can begin. In 404, the entry of a newly arriving bus or other large-sized vehicle in the parking area 122 can be detected, again for instance via the set of sensors 106, embedded magnetic pavement loops, optical beam sensors, and/or other types of detection. In 406, once or more occupants of the bus or other large-scale vehicle can disembark or leave the vehicle, and the model 118, production management engine 114, and/or other logic, application, and/or service can estimate a number of occupants leaving the vehicle, again, based on face detection, thermal detection, and/or other sensing technology or techniques applied to those individuals as they depart from the vehicle, in serial fashion or otherwise.

In 408, the model 118, production management engine 114, and/or other logic, application, and/or service can generate a set of dynamically generated production instructions 120 based on the estimated number of occupants in the bus or other large-scale vehicle arriving or parking in the parking area 122. Thus, for instance, if twenty occupants are detected in the bus or other vehicle, the set of dynamically generated production instructions 120 can include instructions to begin preparation of fifteen hamburgers, eighteen orders of French fries, and/or other combinations or quantities of food items. In 410, the occupants of the bus or other vehicle can disembark from the vehicle and enter the retail site 102, where the actual order of the occupant(s) can be received and/or delivered, again with enhanced efficiency based on the more-accurate estimate of occupants leaving the bus or other vehicle and entering the site to place an order. In 412, processing can return to a prior processing point, jump to a further processing point, repeat, or end.

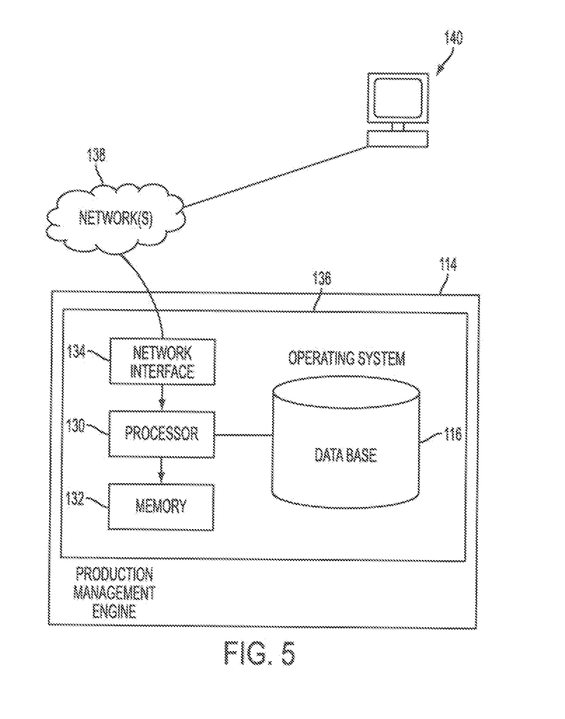

FIG. 5 illustrates various hardware, software, and other resources that can be used in implementations of systems and methods for realtime occupancy detection of vehicles approaching a retail site for predictive ordering, according to embodiments. In embodiments as shown, the production management engine 114 and/or other server, platform, application, portal, and/or service can comprise a platform including processor 130 communicating with memory 132, such as electronic random access memory, operating under control of or in conjunction with an operating system 136. The processor 130 in embodiments can be incorporated in one or more servers, clusters, and/or other computers or hardware resources, and/or can be implemented using cloud-based resources. The operating system 136 can be, for example, a distribution of the Linux™ operating system, the Unix™ operating system, or other open-source or proprietary operating system or platform. The processor 130 can communicate with the episode database 116, such as a database stored on a local hard drive or drive array, to access or store the model 118, operational data include point-of-sale data for retail site 102 and/or other local or remote affiliated sites, or other sites, along with other content, media, or other data. The processor 130 can further communicate with a network interface 134, such as an Ethernet or wireless data connection, which in turn communicates with the one or more networks 138, such as the Internet or other public or private networks, via which production management engine 114 and/or other server, platform, application, portal, and/or service can communicate with other local or remote resources, such as an administrative terminal 140 connected to the production management engine 114 via the Internet. The processor 130 can, in general, be programmed or configured to execute control logic and control production operations of the retail site 102, including to generate the set of dynamically generated production instructions 120 and other data or output. In aspects, other resources including model 108 can be or include resources similar to those of the production management engine 114 and/or other server, platform, application, portal, and/or service, and/or can include additional or different hardware, software, and/or other resources. Other configurations of the production management engine 114, model 118, associated network connections, and other hardware, software, and service resources are possible.

The foregoing description is illustrative, and variations in configuration and implementation may occur to persons skilled in the art. For example, while embodiments have been described in which one local production management engine 114 controls the information processing activities of one retail site 102, in embodiments, one remote and/or network-accessible production management engine 114 can control multiple retail sites. Similarly, while embodiments have been described in which a retail site 102 has one access roadway 110 and one parking area 106, in implementations, retail site 102 can maintain multiple access roadways and/or parking areas, each of which can have dedicated sets of sensors provided to monitor those respective access areas. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of managing a retail site, comprising:
monitoring an access area to an ordering point of the retail site;
identifying the presence of a vehicle entering the access area of the retail site;
detecting a number of occupants of the vehicle;
transmitting the number of occupants to a production management engine; and
generating, via the production management engine, a set of dynamically generated production instructions based on the detected number of occupants to manage a production process of the retail site.

2. The method of claim 1, wherein the access area comprises at least one of an access roadway or a parking area.

3. The method of claim 1, wherein the retail site comprises a restaurant.

4. The method of claim 1, wherein the detecting comprises detecting the number of occupants using optical imaging.

5. The method of claim 4, wherein the optical imaging comprises the use of an infrared strobe.

6. The method of claim 4, wherein the optical imaging comprises applying a face recognition algorithm to a detected optical image.

7. The method of claim 4, wherein the optical imaging comprises applying a seat detection algorithm to a detected optical image.

8. The method of claim 1, wherein the detecting comprises detecting the number of occupants using thermal imaging.

9. The method of claim 1, wherein the detecting comprises detecting the number of occupants using acoustic detection.

10. The method of claim 1, wherein the production management engine generates an estimated queue delay for an order received from at least one occupant of the vehicle.

11. The method of claim 10, wherein the set of dynamically generated production instructions comprises a specification of a quantity of at least one food item.

12. The method of claim 10, wherein the set of dynamically generated production instructions comprises a specification of a start time for the processing of at least one food item.

13. The method of claim 12, wherein the production management engine generates an estimated freshness rating for the at least one food item.

14. The method of claim 1, further comprising accessing a model of the retail site to operate the production management engine.

15. The method of claim 14, further comprising receiving order information from at least one occupant of the vehicle at the ordering point.

16. The method of claim 15, further comprising updating the model based on the order information.

17. A production management system for a retail site, comprising:
an interface to a set of sensors to detect occupants of a vehicle; and
a processor, communicating with the set of sensors via the interface, the processor being configured to
monitor an access area to an ordering point of the retail site via the set of sensors,
identify the presence of a vehicle entering the access area of the retail site,
detect a number of occupants of the vehicle,
receive the detected number of occupants, and
generate a set of dynamically generated production instructions to manage a production process of the retail site based on the detected number of occupants.

18. The system of claim 17, wherein the access area comprises at least one of an access roadway or a parking area.

19. The system of claim 17, wherein the retail site comprises a restaurant.

20. The system of claim 17, wherein the detecting comprises detecting the number of occupants using optical imaging.

21. The system of claim 20, wherein the optical imaging comprises the use of an infrared strobe.

22. The system of claim 20, wherein the optical imaging comprises applying a face recognition algorithm to a detected optical image.

23. The system of claim 20, wherein the optical imaging comprises applying a seat detection algorithm to a detected optical image.

24. The system of claim 17, wherein the detecting comprises detecting the number of occupants using thermal imaging.

25. The system of claim 17, wherein the detecting comprises detecting the number of occupants using acoustic detection.

26. The system of claim 17, wherein the processor is further configured to generate an estimated queue delay for an order received from at least one occupant of the vehicle.

27. The system of claim 26, wherein the set of dynamically generated production instructions comprises a specification of a quantity of at least one food item.

28. The system of claim 26, wherein the set of dynamically generated production instructions comprises a specification of a start time for the processing of at least one food item.

29. The system of claim 28, wherein the processor is further configured to generate an estimated freshness rating for the at least one food item.

30. The system of claim 17, wherein the processor is further configured to access a model of the retail site to operate the production management engine.

31. The system of claim 30, wherein the processor is further configured to receive order information from at least one occupant of the vehicle at the ordering point.

32. The system of claim 31, wherein the processor is further configured to update the model based on the order information.
